(19) United States
(12) Patent Application Publication
(10) Pub. No.: US 2016/0167674 A1
(43) Pub. Date: Jun. 16, 2016

(54) TELEMATICS ENABLED DRIVERS EDUCATION

(71) Applicant: Continental Automotive Systems, Inc., Auburn Hills, MI (US)

(72) Inventors: David Zeiger, Mundelein, IL (US); Wai-Tak Ho, Hoffman Estates, IL (US)

(21) Appl. No.: 14/567,661

(22) Filed: Dec. 11, 2014

(51) Int. Cl. B60W 40/09; G09B 19/16; G01C 21/26

(52) U.S. Cl. CPC B60W 40/09; G01C 21/26; G09B 19/167; B60W 2540/30

(57) ABSTRACT

Driving skills of a driver are objectively monitored in real time using a telematics system, a navigation system, and a processor, which is configured to receive data from the telematics system that defines a predetermined vehicle operation the vehicle driver is to perform. The driver's completion of the vehicle operation is monitored and displayed on a display screen. The driver's deviation from a standard or reference model can also be displayed or uploaded to a driver training service provider.

### BACKGROUND

It is well known that people who have little or no automobile driving experience are more likely to be involved with or the cause of a collision or “accident” than are drivers who are experienced. Most states require new drivers to prove they have a minimum number of hours driving a vehicle with a more experienced licensed driver. In the United States, new drivers typically get their required driving experience time by driving a vehicle, accompanied by a parent or other relative or a friend. Driving with a relative or friend, however, does not necessarily give a new driver specific training needed and the feedback from a friend or relative is often ineffective. An apparatus for tracking driving experience, capability, and for objectively evaluating a driver would be an improvement over the prior art.

### BRIEF SUMMARY

In accordance with embodiments of the invention, driving skills of a driver are objectively monitored in real time using a telematics system, a navigation system, and a processor, which is configured to receive data from the telematics system that defines a predetermined vehicle operation the vehicle driver is to perform. The driver's completion of the vehicle operation is monitored and displayed on a display screen. The driver's deviation from a standard or reference model can also be displayed or uploaded to a driver training service provider.

### BRIEF DESCRIPTION OF THE DRAWINGS

FIG. 1 depicts a system that provides telematics-enabled drivers education;

FIG. 2 depicts a sample of vehicle operations, route data, or descriptions of which, can be downloaded to a vehicle telematics system from a telematics service provider;

FIG. 3 depicts steps of a method for tracking and evaluating driving skills of a vehicle driver in real time using a telematics system;

FIG. 4 depicts the display of a parallel parking maneuver to be performed by a driver, image data of which is wirelessly provided to the vehicle from a telematics service provider;

FIG. 5 depicts the display of how a driver incorrectly performed the parallel parking maneuver shown in FIG. 4;

FIG. 6 depicts the display of a street map, a starting point and an ending point between which a driver is expected to drive a vehicle; and

FIG. 7 depict an actual route taken by a driver between the starting and ending points and an optimum path preferred by a driver training service provider.

### DETAILED DESCRIPTION

As used herein, the term “bus” refers to a set of parallel conductors in a computer system that forms a main transmission path for components and device that make up a computer system. “Real time” refers to the actual time during which something takes place.

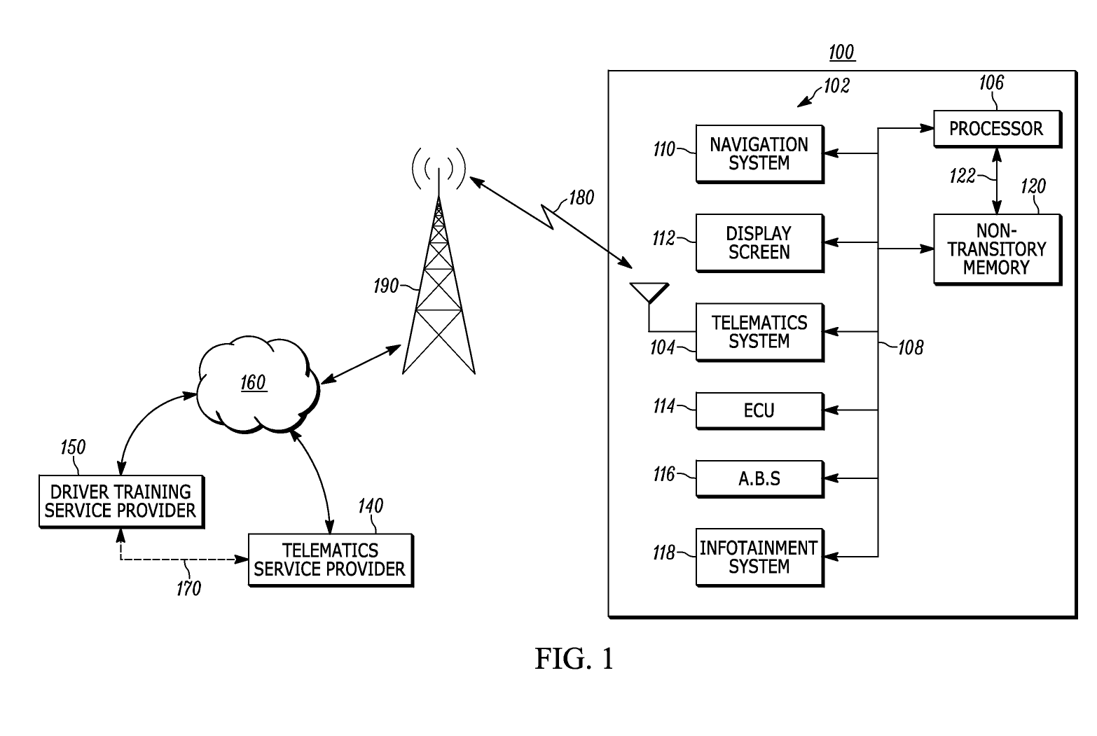

FIG. 1 is a block diagram of a system 100 for tracking and evaluating driving skills of a vehicle driver in real time. The system comprises a vehicle 102 having a conventional telematics system 104 which is coupled to a processor or controller 106 through a controller area network bus 108. The controller area network or “CAN” bus also couples the processor 106 to several other peripheral devices.

A navigation system 110, preferably a global positioning system (GPS), continuously monitors the location of the vehicle 102 and provides location to the processor 106 over the CAN bus 108 in real time as the vehicle 102 is driven about by a driver, not shown. The navigation system 110 thus provides real time location information to the processor 106.

A conventional display screen 112, preferably embodied a touch-sensitive screen capable of receiving tactile inputs and displaying text and images, is configured to display both text and graphical images responsive to signals that the display screen 112 receives from the processor 106 via the bus 108.

An engine control unit or ECU 114 continuously monitors the vehicle's engine (omitted from FIG. 1 for brevity and clarity) as well as the transmission (omitted from FIG. 1 for brevity and clarity) and can provide information about the vehicle operation to the processor 106.

An anti-lock braking system or ABS system 116 is also coupled to the processor 106 via the bus 108. It provides information about braking and turning. An “infotainment system 118,” which includes the vehicle's audio system, provides information about audio and entertainment system and usage to the processor 106 via the bus 108.

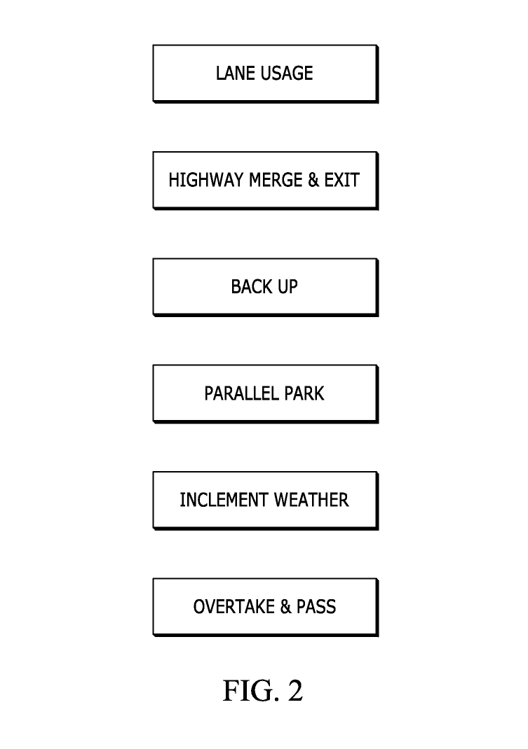

A non-transitory memory device 120 stores executable instructions and data and is coupled to the processor 106 via a conventional address/data/control bus. Stored program instructions, when executed by the processor 106, cause the processor to send and receive control signals to and from the various peripheral devices 110, 112, 104, 114, 116 and 118. Among other things, the instructions effectively cause the processor 106 to receive data (information) from the telematics system 104 that describe or define a particular vehicle operation that a driver is to perform in order to evaluate the driver's ability to operate a vehicle competently. Examples of such operations are provided in FIG. 2 and include but are not limited to proper lane usage, e.g., use of turn signal indicators; merging onto and off of a highway; backing the vehicle up down a straight line or around a curve; parallel parking; driving in all forms of inclement weather and overtaking and passing vehicles on an expressway.

Other program instructions in the memory 120 cause the processor 106 to create and display on the display device 112 graphic images that depict or represent the vehicle operation that the driver is to perform. Graphics or graphic images that depict what a driver is to do while operating the vehicle are blanked or removed from the display screen after they are presented to the driver and the driver begins to operate the vehicle.

Still other instructions cause the processor 106 to monitor the vehicle operation, as reported to the processor 106 by the ECU 114, ABS 116, infotainment system 118, et al., during a driver's performance of various vehicle operations described to a driver by the processor 106 using the display device 112. Vehicle performance operation, and thus driver capability, is obtained from the engine control unit 114, an anti-lock braking system 116, an informatics system 118 and other peripheral devices that are coupled to the controller area network bus but which are omitted from FIG. 1 for brevity.

As a driver operates the vehicle 102, location information obtained from the navigation system 110, speed and braking information obtained from the engine control unit 114 and ABS system 116, are compared to a model or exemplary pathway information that is received through the telematics stem 104 and stored in the memory device 120. Program instructions in the memory device cause the processor 106 to determine a driver's deviation from an ideal or exemplary performance of a desired operation to what a driver actually does. An evaluation of the driver's performance of a operation is tabulated by the processor. Program instructions in the memory device 120 cause the processor to create a series of images that are displayed on the display screen 112 that represent the vehicle's actual operation by the driver and a representation of the same operation according to an ideal standard.

In a preferred embodiment, data representing the driver's actual performance of an actual operation is accumulated by the processor 106 and stored in the memory device 120. Data representing the driver's actual control of an operation is obtained from the memory device 120, provided to the telematics system 104 and transferred by the telematics system 104 to a telematics service provider 140. The telematics service provider 140 in turn sends the driver performance data to a driver training service provider 150 via a network such as the internet 160 or another connection 170 such as a dial-up telephone service. A link 180 between the vehicle 102 and the telematics service provider 140 is provided by a conventional cellular network 190 and either a telephone connection 192 or an internet link 160.

In a preferred embodiment, the processor 106 can also provide an evaluation message made up of either icons or text, presented on the display screen 112. The evaluation message preferably shows how a driver's operation of the vehicle deviated from a predetermined driving performance standard or ideal model.

In another embodiment, the display screen 112, preferably a tactile input screen, receives input information that uniquely identifies both the driver and a proctor or supervisor, commonly required by many states for underage or new permit only drivers. Such information might be the driver's license number, a social security number, or a user ID provided to the supervisory driver by a governmental agency. The system 100 thus provides a mechanism for tracking the time that a driver, especially a new driver, actually operates a vehicle under the supervision of a proctor.

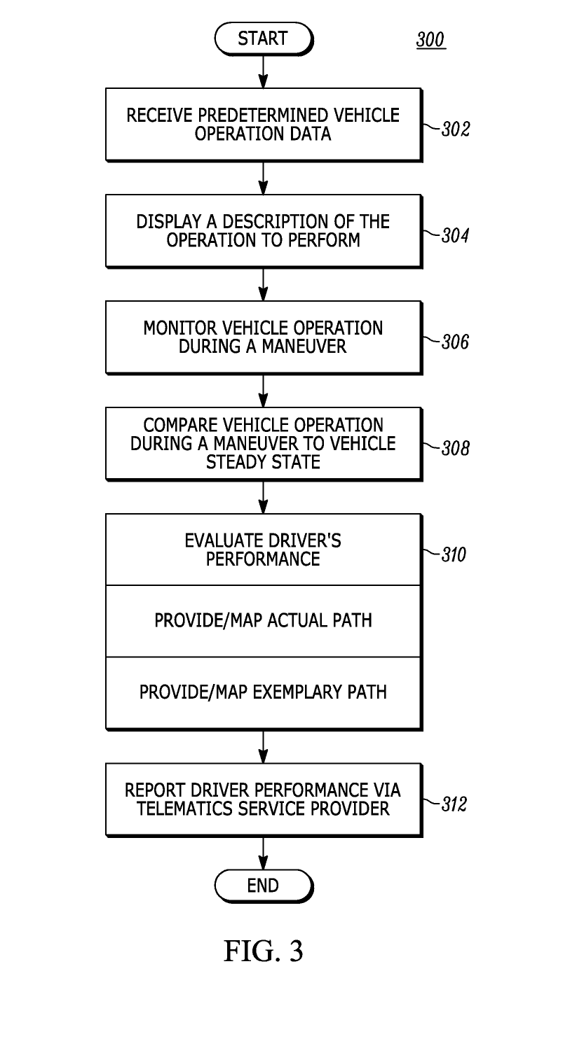

Referring now to FIG. 3, a method for tracking and evaluating the driving skills of a vehicle driver in real time is shown. The method 300 begins at step 302 where a vehicle receives via a telematics system, a map, written description or a graphical depiction of a route to be driven. In a preferred embodiment, step 302 also includes an instruction of a particular operation that the driver is to perform such as parallel parking the vehicle at a predetermined location.

At step 304, an animated or graphical depiction of the operation to perform is displayed on a display device, such as a touch-sensitive display screen in the instrument panel of an automobile. By way of example, step 304 provides that the parallel parking maneuver be displayed in slow motion on the in-dash display monitor while the vehicle is stopped or in a parked position.

After a predetermined delay time, not shown, the display of the operation to be performed is removed from the display device whereupon the performance of the depicted operation begins at step 306. During step 306, or as part of step 306, the vehicle's movement is recorded by reading signals and information obtained from the vehicle's engine control unit (ECU), anti-lock brake system (ABS) and/or other electronic devices that enable the comparison of the vehicle's operation during a maneuver, to an exemplary or ideal way to perform an operation that was provided to the vehicle at step 302.

In step 310, the driver's performance is evaluated by providing a map or other representation of an actual pathway taken by the vehicle and a comparison of the actual pathway to an exemplary pathway. Deviations from the exemplary pathway by the actual pathway are quantified by measuring distance differences between the two paths.

At step 312 a quantification of the driver's deviation from an ideal or exemplary pathway is recorded in a non-transitory memory device. It can be optionally uploaded to a driver's education service provider through the telematics device.

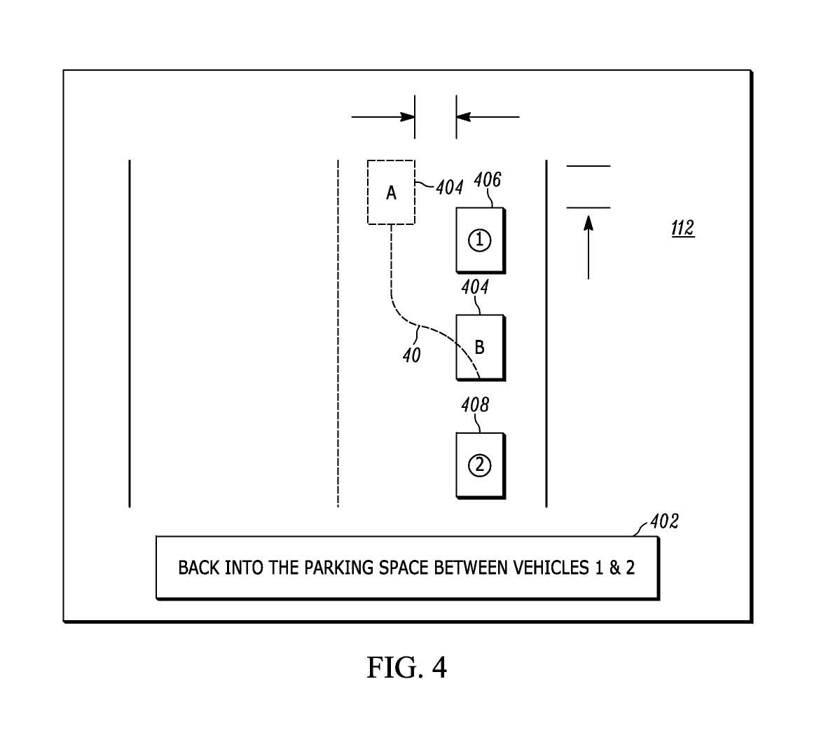

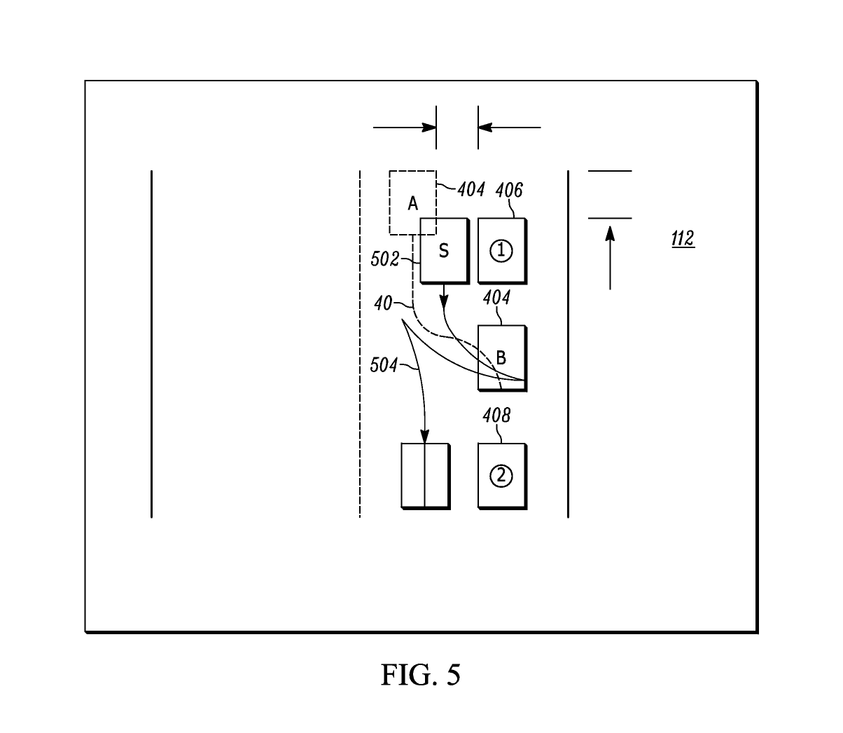

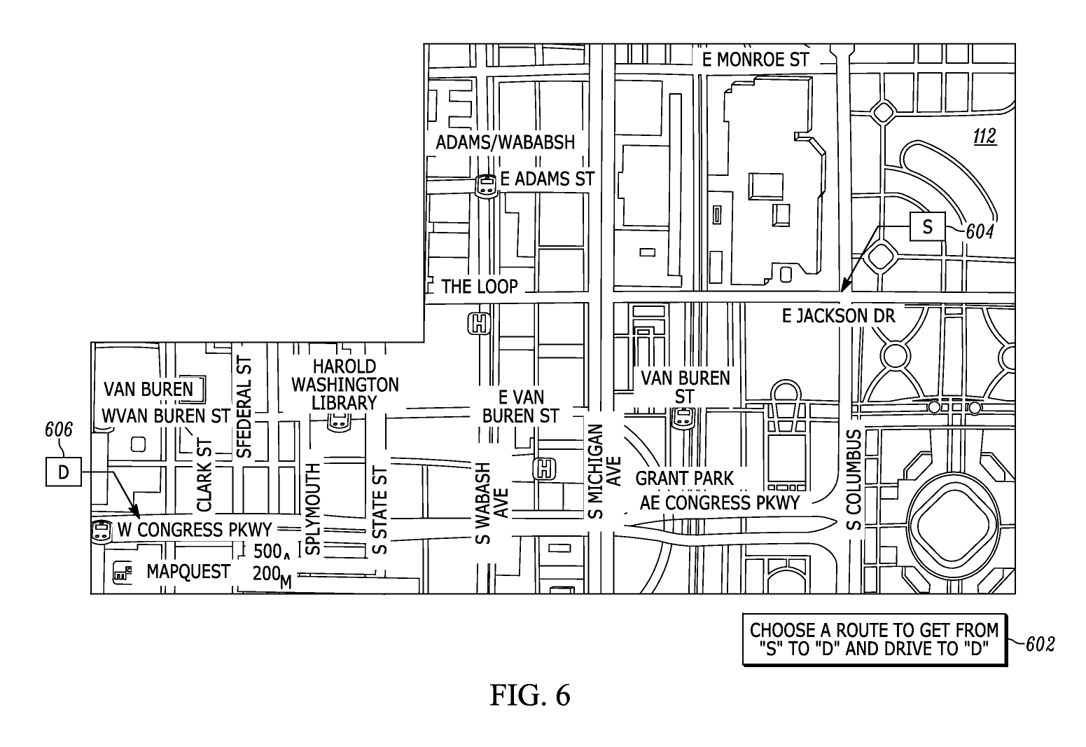

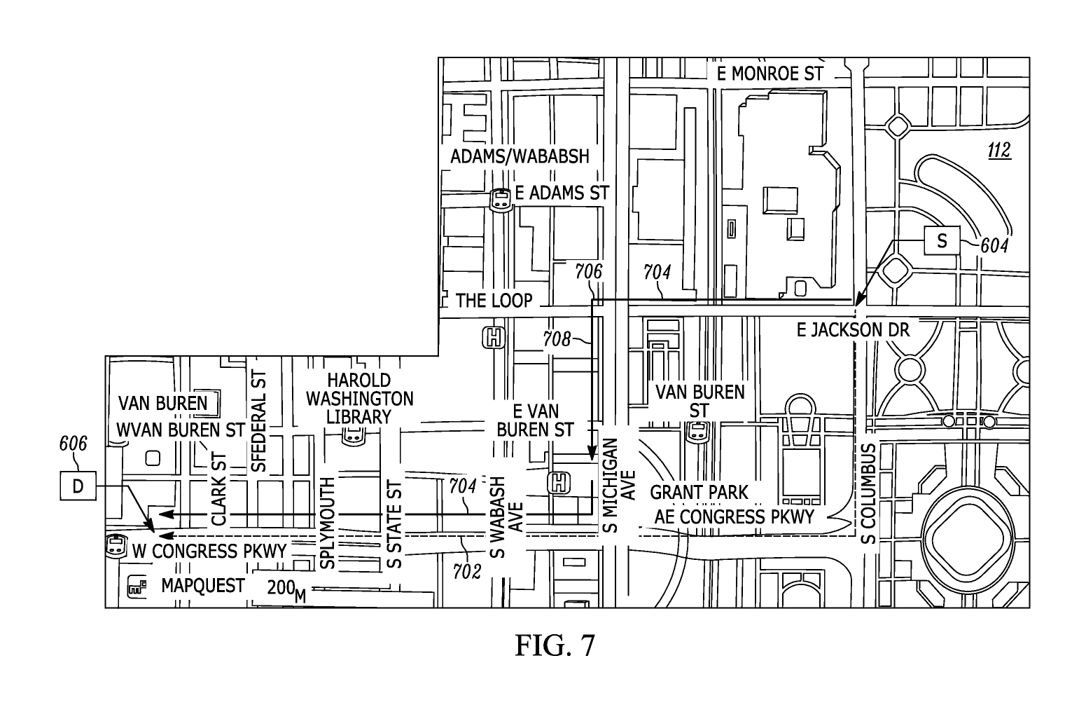

The operation and use of the apparatus and method described above are illustrated in FIGS. 4-7. More particularly, FIGS. 4 and 6 depict graphical displays of two different maneuvers for a driver to perform, and which are received from a driver training service provider via a telematics system. FIGS. 5 and 7 depict graphical displays of how the maneuvers shown in FIGS. 4 and 6 respectively might be actually attempted by a driver.

Driving maneuvers to perform and exemplary models thereof are received as image and text data via the telematics system 104. A driver's actual performance of a maneuver, i.e., how well or poorly a driver performed a maneuver, is determined using a navigation system and vehicle operation data. Deviation of a driver from a model or exemplar is determined by the processor 106 and sent back to a driver training service provider 150 via the telematics system 104.

Referring now to FIG. 4, a text message 402 provided to the display device 112 by the processor 106, and which was received via the telematics system 104, instructs a driver to back into a parking space 404 located between two parked vehicles 406, 408, i.e., parallel park. A model or exemplary pathway 410 to follow, and which is also received via the telematics system 104, is also provided to the display device 112 by the processor 106 as a learning assist.

After a driver has attempted a driving maneuver, such as the parallel parking maneuver depicted in FIG. 4, the maneuver that was actually attempted by the driver, as determined by the navigation system 110, is overlaid the model pathway 410 and displayed at the same time on the display device 112.

In FIG. 5, reference numeral 502 identifies an icon that depicts where a driver's vehicle location started a parallel parking maneuver. The location of the vehicle is determined by the navigation system 110.

The pathway actually taken by the vehicle during execution of the parallel parking maneuver is identified by reference numeral 504. The deviation of the actual route 504 taken by the driver, from a model or exemplary route 410 is thus made readily apparent to the driver who can re-attempt the maneuver with the benefit of an objective negative feedback provided by the apparatus and method described above.

More extensive driving maneuvers are shown in FIGS. 6 and 7.

FIG. 6 depicts a portion of a map of Chicago. FIG. 6 also shows a starting point “S” 604 and a destination point “D” 606. A text message 602 received via the telematics system 104 is provided to the display device 112 by the processor 106 and instructs the driver to choose a route between “S” and “D” and instructs the driver to drive to “D” via the driver's chosen route.

FIG. 7 shows a preferred or “model” route 702 as selected by a driver training service provider 150. FIG. 7 also shows an actual route 704 taken by a driver between “S” and “D.” FIG. 7 thus shows the route chosen by a driver 704 and thus the driver's deviation from a model route 702.

In FIG. 7, a left turn executed by the driver at the corner of Jackson Drive and South Michigan Avenue should be preceded by a left-turn signal. Data provided to the processor 106 by an ECU 114 or other controller in the vehicle 102 thus provides an objective determination of whether the driver properly negotiated the left-hand turn.

A driver's compliance with a posted speed limit along a portion 708 of a driver's route 704 on South Michigan Avenue, as indicated by either a navigation system 110 or an ECU 114 provides another objective determination of whether a driver properly obeyed traffic speed limits.

Proper and/or improper lane usage and speed, as provided by a navigation system and/or ECU, along at least a portion of East Congress Parkway identified by reference numeral 704, are detected by the processor 106, uploaded to a driver training service provider 150 through the telematics system 104 and provides yet another objective indicator of a driver's compliance with traffic laws and a driving ability.

Those of ordinary skill in the art will recognize that the apparatus and method described above provides telematics-enabled driver education in real time. Subjectivity in the evaluation of a driver's capabilities is eliminated, reducing the likelihood of driver training falsification.

The foregoing description is for purposes of illustration only. The true scope of the invention is set forth in the following claims.

1. A system for tracking and evaluating the driving skills of a vehicle driver in real time, the system comprising:
a telematics system capable of being operatively coupled to a telematics service provider through a wireless communications link;
a display screen coupled to the telematics system and configured to display images thereon;
a navigation system configured to continuously determine the location of the vehicle as it is driven by the vehicle driver;
a processor coupled to the telematics system, the touch-sensitive display screen and the navigation system;
a non-transitory memory device coupled to the processor and storing program instructions, which when executed cause the processor to:
receive data from the telematics system that define a predetermined vehicle operation the vehicle driver is to perform in real time, the predetermined vehicle operation being selected from a set of operations to determine the vehicle driver's competency to operate a motor vehicle;
display on the touch-sensitive display screen, a representation of the predetermined vehicle operation to perform;
monitor vehicle operation during performance of the predetermined vehicle operation;
compare the driver's performance of the predetermined operation to a predetermined reference; and
provide an evaluation of the driver's performance of the predetermined vehicle operation.

2. The system of claim 1, wherein the evaluation of the driver's performance comprises displaying on the display screen, a representation of the vehicle's actual operation and a representation of the predetermined reference for the same operation.

3. The system of claim 1, wherein the memory device stores program instructions, which when executed cause the processor to send data that represents metrics of the driver's performance of the predetermined vehicle operation over the wireless communications link.

4. The system of claim 3, further comprising instructions, which when executed cause the processor to tabulate metrics of the driver's performance of the predetermined operation over time.

5. The system of claim 1, wherein the memory device stores program instructions, which when executed cause the processor to:
obtain from the navigation system, a location, in which the predetermined vehicle operation can be safely completed by the vehicle driver; and
provide a driving exercise location to the touch-sensitive display screen.

6. The system of claim 1, wherein the evaluation message comprises a graphical display of vehicle icons on the display device showing how the driver actually completed the predetermined vehicle operation and showing the predetermined reference for the same operation.

7. The system of claim 1, wherein the evaluation message comprises a graphical display of vehicle icons on the display device showing how the driver's operation of the vehicle deviated from the predetermined driving performance standard.

8. The system of claim 1, further comprising computer program instructions, which when executed cause the processor to receive from the touch-sensitive display screen, information that identifies a proctor for the driver and receive information that identifies the driver who is to perform the predetermined vehicle operation.

9. A method for tracking and evaluating the driving skills of a vehicle driver in real time, the vehicle having a telematics system, which is capable of being operatively coupled to a telematics service provider through a wireless communications link, the method comprising:
receiving first data from the telematics system, which define a predetermined vehicle operation the vehicle driver is to perform in real time, the predetermined vehicle operation being selected from a set of operations to determine the vehicle driver's competency to operate a motor vehicle;
displaying on a display screen, a representation of the predetermined vehicle operation to perform;
monitoring vehicle operation during the driver's performance of the predetermined vehicle operation; and
providing an evaluation of the driver's performance of the predetermined vehicle operation.

10. The method of claim 9, wherein the step of providing an evaluation of the driver's performance comprises providing a numeric value.

11. The method of claim 9, further comprising the step of receiving second data from the telematics system, the second data representing an exemplary performance of the predetermined vehicle operation to be performed by the driver.

12. The method of claim 11, further comprising: displaying on the display screen, a representation of the vehicle's actual operation by the driver and a representation of the exemplary performance.

13. The method of claim 9, further comprising: sending data that represents metrics of the driver's performance of the predetermined vehicle operation over a wireless communications link.

14. The method of claim 9, further comprising the step of tabulating metrics of the driver's performance of the predetermined operation over time.

15. The method of claim 9, further comprising the steps of:
obtaining a location from a navigation system where the predetermined vehicle operation can be safely completed by the vehicle driver; and
providing a driving exercise location to the display screen.

16. The method of claim 9, the evaluation comprises a graphical display of vehicle icons on the display device showing how the driver actually completed the predetermined vehicle operation and showing a predetermined reference for the same operation.

17. The method of claim 9, wherein the evaluation comprises a graphical display of vehicle icons on the display device showing how the driver's operation of the vehicle deviated from the predetermined driving performance standard.

18. The method of claim 9, wherein the display screen is a touch-sensitive display screen configured to be able to receive tactile inputs and display images, the method further comprising the step of receiving from the display screen, information that identifies a proctor for the driver and receive information that identifies the driver who is to perform the predetermined vehicle operation.
